(19) United States
(12) Patent Application Publication
(10) Pub. No.: US 2024/0201834 A1
(43) Pub. Date: Jun. 20, 2024

(54) Concept for Image Data Processing

(71) Applicant: Intel Corporation, Santa Clara, CA (US)

(72) Inventors: Alex NAYSHTUT, Gan Yavne D (IL); Dan HOROVITZ, Rishon Lezion (IL); Miriam ENGEL, Jerusalem (IL); Victoria ALMOG-AYZENBERG, Haifa (IL); Ilil BLUM SHEM-TOV, Kiryat Tivon (IL)

(21) Appl. No.: 18/477,572

(22) Filed: Sep. 29, 2023

(51) Int. Cl. G06F 3/04845; G06T 7/20; G06T 7/70

(52) U.S. Cl. CPC G06F 3/04845; G06T 7/20; G06T 7/70

(57) ABSTRACT

Examples relate to an apparatus, device, method, and computer program for an image data processing system, to an image date processing system and image data processing method, and to corresponding computer systems and computer programs. An apparatus for an image data processing system is to obtain information on a user selection from a user, the user selection relating to at least one modality of computer-based processing of a depiction of the user the user is comfortable or uncomfortable with, determine a presence of a depiction of the user in image data of a camera, and determine one or more modalities of computer-based processing to be applied to the depiction of the user in the image data based on the user selection, provide control information regarding the one or more modalities of computer-based processing to be applied to the depiction of the user in the image data for the image data processing system.

### BACKGROUND

Today, individuals often face being filmed or photographed when they are in public spaces, as many types of cameras and systems that analyze their behavior patterns are in use. There are several use-cases where individuals are filmed in photographed, e.g., in smart buildings, hospitals, public transportation, street cameras, etc. Some of the video- or photographing systems are closed systems (CCTV, Closed Circuit Television), while others are uploading the data to “on-premises” server and/or to the cloud.

There are different regulations that outline the use cases where users consent is needed for facial recognition. In closed systems, users may be required to accept to the policy enforced by the system. In some countries (such as the United States or Israel), a notification may be required (such as a picture, sign, Quick-Response-code, poster) notifying the users that their picture is processed by recording and face recognition systems. Some members of the photographed population are subject to different privacy regulation laws, such as workers, minors, lawyers, etc.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for providing control information for an image data processing system;

FIG. 1b shows a flow diagram of an example of a method for providing control information for an image data processing system;

FIG. 2a shows a schematic diagram of an example of an image data processing system;

FIG. 2b shows a flow chart of an example of an image data processing method;

FIG. 3 shows a schematic diagram of a video surveillance system; and

FIG. 4 shows a schematic diagram of an example of the proposed concept.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

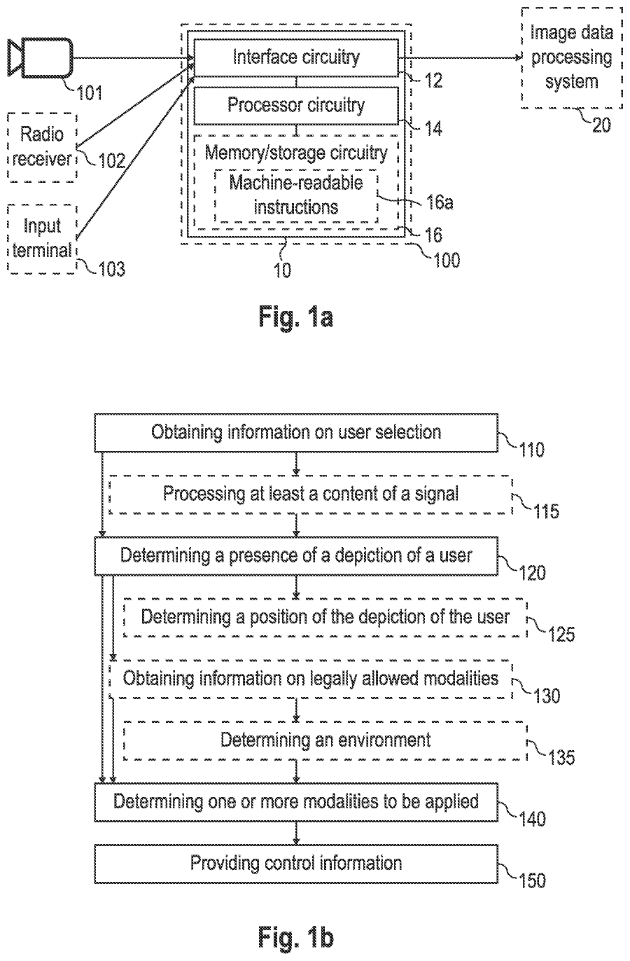

FIG. 1a shows a schematic diagram of an example of an apparatus 10 or device 10 for providing control information for an image data processing system 20, and of a computer system 100 or system comprising the apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processor circuitry 14, and (optional) memory/storage circuitry 16. For example, the processor circuitry 14 may be coupled with the interface circuitry 12, with the memory/storage circuitry 16. For example, the processor circuitry 14 may provide the functionality of the apparatus, in conjunction with the interface circuitry 12 (for exchanging information, e.g., with other components inside or outside the computer system 100 comprising the apparatus or device 10, a camera 101, a radio receiver 102, or an input terminal 103), the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory/storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processor circuitry 14 or means for processing 14 is to obtain information on a user selection from a user. The user selection relates to at least one modality of computer-based processing of a depiction of the user the user is comfortable or uncomfortable with. The processor circuitry 14 or means for processing 14 is to determine a presence of a depiction of the user in image data of a camera 101. The processor circuitry 14 or means for processing 14 is to determine one or more modalities of computer-based processing to be applied to the depiction of the user in the image data based on the user selection. The processor circuitry 14 or means for processing 14 is to provide control information regarding the one or more modalities of computer-based processing to be applied to the depiction of the user in the image data for the image data processing system 20.

FIG. 1a further shows a computer system 100 comprising the apparatus 10 or device 10. FIG. 1a further shows a system comprising the apparatus 10 or device 10 and the camera 101. FIG. 1a further shows a system comprising the apparatus 10 or device 10 and the image data processing system 20. FIG. 1a further shows a system comprising the apparatus 10 or device 10, the image data processing system 20, and the camera 101. In some examples, at least one of the systems may further comprise at least one of the radio receiver 102 and the input terminal 103.

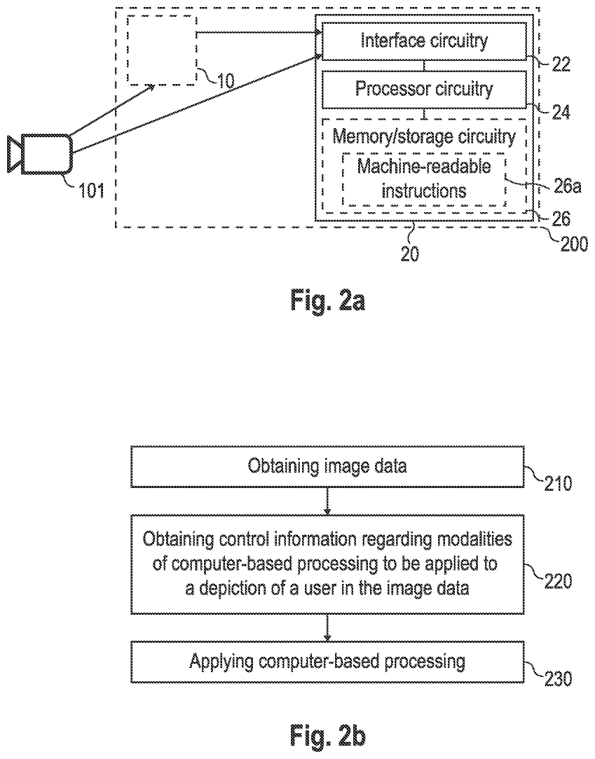

FIG. 1b shows a flow diagram of an example of a corresponding method for providing control information for the image data processing system 20. The method comprises obtaining 110 the information on the user selection from the user. The method comprises determining 120 the presence of a depiction of the user in the image data of the camera 101. The method comprises determining 140 the one or more modalities of computer-based processing to be applied to the depiction of the user in the image data based on the user selection. The method comprises providing 150 the control information regarding the one or more modalities of computer-based processing to be applied to the depiction of the user in the image data for the image data processing system 20. For example, the method may be performed by the computer system 100, the apparatus 10 or device 10, or one of the above-referenced systems. In some examples, the computer system 100, the apparatus 10 or device 10, or one of the above-referenced system, may further perform the method of FIG. 2b.

In the following, the apparatus 10, device 10, computer system 100, method, and a corresponding computer program will be introduced in more detail with reference to the apparatus 10. Features introduced in connection with the apparatus 10 may likewise be included in the corresponding device 10, computer system 100, method, and corresponding computer program.

Various examples of the present disclosure relate to the processing of image data, and in particular to privacy aspects of the processing of image data. In general, the processing of image data provides a number or advantages with respect to location security, automation, statistics etc., and is therefore highly desirable. However, many persons are uncomfortable with various forms of image processing, such as person identification and tracking of persons across multiple cameras. Moreover, privacy regulations around the world regulate the amount in of processing that can be performed on (video) image data with and without obtaining a consent of the persons shown in the image data. While such a consent can be obtained in closed systems, e.g., for video surveillance of a company campus that is only accessible for company employees, this is usually not possible in public spaces, such as airports, schools, public transportation etc. Therefore, to avoid violating privacy regulations, the amount of video processing is often limited to the lowest common denominator, which degrades the usefulness.

Examples of the present disclosure are based on the finding that technological measures enable obtaining a user-specific consent to different amounts of image processing being performed on the depiction of a user. For example, as will be shown in the following, a radio beacon (via a radio receiver 102), a visual identifier (via a camera 101), or an input terminal 103 may be used by the user to communicate to the image data processing system which amount (i.e., modalities) of image data processing are acceptable to the user. While the following examples are given with respect to a single user, various examples can be used to process the user selection of a plurality of users concurrently or in short order, e.g., for mass gatherings, conferences, busy airports or public transportation hubs etc.

The process starts with the user providing the user selection related to the at least one modality of computer-based processing of a depiction of the user the user is comfortable or uncomfortable with. By providing the user selection, the user signals to the apparatus 10 (and, transitively, to the image data processing system 20), which type, or types of image data processing are (not) to be applied on depictions of the user shown in the image data. In other words, for the case that a depiction (e.g., an image) of the user is shown (at least partially) in the image data, the user selection is used to determine which type or types (i.e., which modality or modalities) of image data processing is/are allowed (or disallowed) on the depiction of the user in the image data. There are various modalities or levels of image data processing the user can register their consent or dissent to. For example, a modality of computer-based processing may be one of storing of the depiction of the user (e.g., the depiction being stored longer than necessary for real-time image data processing in a database or video archive, e.g., for the purpose of training a machine-learning model, such as a generative machine-learning model, or for a video surveillance archive), person detection being applied on the depiction of the user (e.g., a machine-learning model being used to detect the presence of the user, e.g., a specific user, in the image data), person identification being applied on the depiction of the user (e.g., a machine-learning model being used to identify or re-identify the user in the image data), multi-camera tracking being applied on the depiction of the user (e.g., with the help of person re-identification systems), and processing of the depiction of the user by a machine-learning based system (i.e., any kind of machine-learning based processing).

In general, the user selection may be a positive selection, i.e., a selection specifying one or more modalities of computer-based processing that the user consents to with respect to depictions of the user in the image data, a negative selection, i.e., a selection specifying one or more modalities of computer-based processing that the user does not consent to (i.e., dissents, disallows) with respect to depictions of the user in the image data, or both.

As outlined above, the user selection (i.e., the information on the user selection indicating the user selection) may be obtained in various ways. For example, a radio beacon (e.g., active radio transmitters) may be used by the user to broadcast the user selection. Radio beacons are small, unobtrusive, and generally work even if there is no line-of-sight between the beacon and the receiver. The processor circuitry may obtain the information on the user selection from a signal emitted by a radio beacon carried by the user, e.g., via the radio receiver 102. For example, the processor circuitry may obtain the information on the user selection from the radio beacon via the radio receiver 102. Alternatively, the radio beacon may provide received signal(s) to the processor circuitry (e.g., via the interface circuitry 12), which may decode the signal(s) to obtain the information on the user selection. In other words, the processor circuitry may process at least a content (e.g., the content, or the content and at least one of a signal strength, an angle of arrival, and a timestamp) of the signal emitted by the radio beacon carried by the user to determine the information on the user selection. Accordingly, as further shown in FIG. 1b, the method may comprise processing 115 at least the content of the signal emitted by the radio beacon carried by the user to determine the information on the user selection. Various types of radio signals may be used for this purpose. For example, the signal may be one of a Bluetooth signal, a WiFi signal, a Near-Field Communication signal and a cellular communication signal. However, these are merely examples. Any kind of radio signal being suitable for transmitting binary information may be used for this purpose.

Active radio beacons are not the only approach for obtaining the user selection. For example, (active or passive) visual tags (such as one-dimensional or two-dimensional visual codes being printed/shown on a badge or button, active light sources with modulated lights etc.) may be used instead. Visual tags are cheap and easier to link to a specific user than radio beacons. For example, the processor circuitry may obtain the information on the user selection from a visual tag worn by the user and included (i.e., shown) in the image data. For example, the processor circuitry may process the image data to detect the visual tag, and to decode the visual tag (e.g., the visual code or modulated light) to obtain the information on the user selection. As yet another alternative, a manual input via an input terminal may be used. For example, the processor circuitry may obtain the information on the user selection from a manual input provided by the user at an input terminal 103. For example, such an input terminal 103 may be placed at an entry to a public or semi-public location, such as a convention hall or auditorium, and used to register the user selection for the respective user. This way, the user does not have to carry a visual identifier or a beacon.

After (or while) registering the user selection, the processor circuitry 14 determines the presence of the depiction of the user in image data of a camera 101. In some cases, such as in the case of using a visual tag, both may be done at the same time. Alternatively, e.g., when using a radio beacon or a manual user input, the user selection and the user depiction may be automatically linked with another. For example, the processor circuitry may process the signal emitted by the radio beacon to determine an angle of arrival of the signal to determine an estimated position of the depiction of the user in the image data (e.g., based on a known position of the radio receiver 102 relative to the field of view of the camera 101 providing the image data). Similarly, in case of the use of an input terminal, the estimated position of the depiction of the user in the image data may be based on the position of the input terminal 103 relative to the camera 101. The processor circuitry may use image processing (e.g., a machine-learning model) to determine one or more bounding boxes of one or more persons shown in the image data). The processor circuitry may link the user selection obtained from signal emitted by the radio beacon or the user selection obtained via the input terminal based on a correspondence between the estimated position of the depiction of the user in the image data and the one or more bounding boxes.

When the depiction of the user and the user selection are linked to each other, both may be used to determine the one or more modalities of computer-based processing to be applied to the depiction of the user in the image data. In a straightforward implementation, the one or more modalities of computer-based processing to be applied to the depiction of the user in the image data are derived solely from the user selection, e.g., by checking the user selection with respect to whether the user has consented or dissented to the one or more modalities according to the user selection.

In some other cases, the user selection is only one aspect. Another aspect is the legal side, i.e., which modalities of computer-based processing are legally allowed or even mandated. For example, in high-security areas, such as airports or ferry terminals, or private spaces, such as company campuses, computer-based image processing may be prescribed that goes beyond the user selection. On the other hand, in other places that may be linked to discriminations, such as near religious places or in places in or around clinics, the modalities of computer-based processing legally allowed may disallow modalities that the user has explicitly allowed. For example, the legally allowed modalities of computer-based processing may be country- and/or location specific and based on a legal framework under which the image data processing system is used. Therefore, the one or more modalities of computer-based processing to be applied to the depiction of the user might not only be based on the user selection but also on information on legally allowed modalities. In other words, the processor circuitry may obtain information on legally allowed modalities of computer-based processing and determine the one or more modalities of computer-based processing to be applied to the depiction of the user in the image data further based on the information on the legally allowed modalities of computer-based processing. Accordingly, as further shown in FIG. 1b, the method may comprise obtaining 130 the information on the legally allowed modalities of computer-based processing and determining 140 the one or more modalities of computer-based processing to be applied to the depiction of the user in the image data further based on the information on the legally allowed modalities of computer-based processing.

One major factor of the legality of the different modalities is the environment in which the image data is collected. For example, as outlined above, in some environments, such as security areas of airports or ferry terminals, some modalities may be legally mandated, while in other environments, such as near religious places or clinics, some modalities may be legally disallowed. For example, the processor circuitry may determine the environment the image data is recorded in, and to determine the one or more modalities of computer-based processing to be applied to the depiction of the user in the image data based on the legally allowed modality of computer-based processing of the environment. Accordingly, as further shown in FIG. 1b, the method may comprise determining 135 the environment the image data may be recorded in and determining 140 the one or more modalities of computer-based processing to be applied to the depiction of the user in the image data based on the legally allowed modality of computer-based processing of the environment. For example, the environment may be determined to be one of a pre-defined number of environments, i.e., the environment may be in one of a pre-defined selection of categories. For example, the environment may be one of a public environment, a public transportation environment, an airport environment, a corporate environment, and a private environment. Depending on the category of the environment, corresponding legally allowed modalities may be determined.

Once the one or more modalities have been determined, the control information regarding the one or more modalities of computer-based processing to be applied to the depiction of the user in the image data are provided for the image data processing system 20, e.g., to the image data processing system 20. For example, the control information may include a pre-defined data structure, such as bit vector or a structured document (e.g., in extensible Markup Language or JavaScript Object Notation) that specifies the one or more modalities. In addition, the control information may specify the position of the user depiction on which the one or more modalities are to be applied. This way, the image data processing system can link the information on the one or more modalities to the “right” depiction. For example, the processor circuitry may determine a position of the depiction of the user in the image data and provide the control information with information on the position of the depiction of the user in the image data. Accordingly, the method may comprise determining 125 the position of the depiction of the user in the image data and providing 150 the control information with information on the position of the depiction of the user in the image data. For example, determining the position of the depiction of the user in the image data may be performed as described above, e.g., using image processing (e.g., a machine-learning model) to determine one or more bounding boxes of one or more persons shown in the image data. For example, the information on the position of the depiction may be included as coordinates of a bounding box.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 10, device 10, computer system 100, system, method and computer program are mentioned in connection with the proposed concept, or one or more examples described above or below (e.g., FIGS. 2a to 4). The apparatus 10, device 10, computer system 100, system, method and computer program may comprise one or more additional optional features corresponding to one or more aspects of the proposed concept, or one or more examples described above or below.

FIG. 2a shows a schematic diagram of an example of an image data processing system 20, of a computer system 200 comprising the image data processing system 20, and of a system comprising the image data processing system. For example, the image data processing system may comprise circuitry to provide the functionality of the apparatus 20. For example, the circuitry of the image data processing system 20 may be configured to provide the functionality of the image data processing system 20. For example, the image data processing system 20 of FIG. 2a may comprise interface circuitry 22, processor circuitry 24, and (optional) memory/storage circuitry 26. For example, the processor circuitry 24 may be coupled with the interface circuitry 22, with the memory/storage circuitry 26. For example, the processor circuitry 24 may provide the functionality of the image data processing system, in conjunction with the interface circuitry 22 (for exchanging information, e.g., with other components inside or outside the computer system 200 comprising the image data processing system or with an apparatus 10, device 10 or computer system 100 providing control information), and the memory/storage circuitry 26 (for storing information, such as machine-readable instructions). In more general terms, the image data processing system 20 may comprise means for providing the functionality of the image data processing system 20. For example, the means may be configured to provide the functionality of the image data processing system 20. The components of the image data processing system 20 may be defined as component means, which may correspond to, or implemented by, the respective structural components of the image data processing system 20. For example, the image data processing system 20 of FIG. 2a may comprise means for processing 24, which may correspond to or be implemented by the processor circuitry 24, means for communicating 22, which may correspond to or be implemented by the interface circuitry 22, (optional) means for storing information 26, which may correspond to or be implemented by the memory/storage circuitry 26. In general, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The image data processing system may comprise the machine-readable instructions, e.g., within the storage circuitry 26 or means for storing information 26.

The processor circuitry 24 or means for processing 24 is to obtain image data from at least one camera 101. The processor circuitry 24 or means for processing 24 is to obtain control information regarding one or more modalities of computer-based processing to be applied to a depiction of a user in the image data. The processor circuitry 24 or means for processing 24 is to apply computer-based processing on the image data according to the control information.

FIG. 2a further shows a computer system 200 comprising the image data processing system 20. In some examples, the computer system 200 may further include the apparatus 10 or device introduced in connection with FIG. 1a. FIG. 2a further shows a system comprising the image data processing system 20 and the apparatus 10 or device 10 introduced in connection with FIG. 1a.

FIG. 2b shows a flow chart of an example of a corresponding image data processing method, i.e., a method for the image data processing system 20. The method comprises obtaining 210 the image data from the at least one camera 101. The method comprises obtaining 220 the control information regarding the one or more modalities of computer-based processing to be applied to the depiction of the user in the image data. The method comprises applying 230 computer-based processing on the image data according to the control information. For example, the method may be performed by the computer system 200 (which may further perform the method of FIG. 1b), e.g., by the image data processing system 20 of computer system 200, or by the above-referenced system.

In the following, the image data processing system 20, computer system 200, method, and a corresponding computer program will be introduced in more detail with reference to image data processing system 20. Features introduced in connection with the image data processing system 20 may likewise be included in the corresponding computer system 200, method, and corresponding computer program.

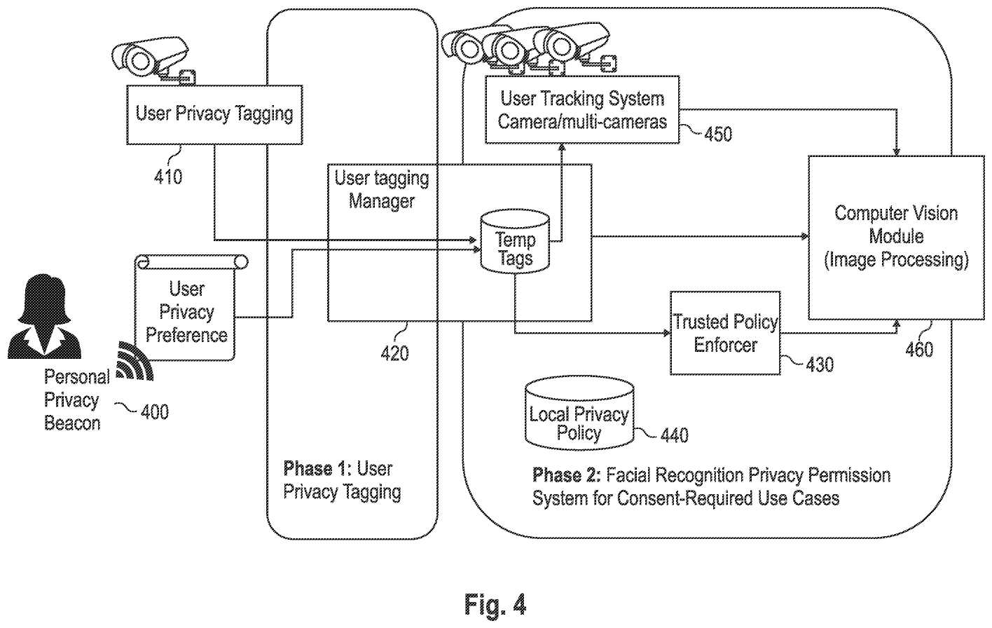

In various examples of the proposed concept, two main components may be distinguished—a component to determine the one or more modalities of computer-based processing (also denoted Privacy Policy Enforcer, PPE, in connection with FIG. 4), and a component to perform the computer-based processing. The former has been discussed in connection with FIGS. 1a and 1b. FIGS. 2a and 2b now relate to the computer-based processing being applied based on the one or more modalities of computer-based processing determined by the first component.

The processor circuitry 24 or means for processing 24 is to obtain image data from at least one camera. This camera may be or include the same camera 101 being used by the apparatus 10 or device 10 of FIG. 1a. Alternatively, as shown in FIG. 4, the at least one camera (depicted as cameras 450 in FIG. 4) may be different from the camera (410) being used by the PPE. For example, the at least one camera may comprise a single camera or a multi-camera system comprising multiple cameras (which may show the same space from different angles or different spaces of a complex, such as an airport, a shop, a museum, a train etc.) In addition to the image data, the processor circuitry 24 or means for processing 24 obtains control information regarding one or more modalities of computer-based processing to be applied to a depiction of a user in the image data. The generation of said control information has been described in connection with FIGS. 1a to 1b. It is used as a basis for the subsequent computer-based processing of the image data, i.e., for the processor circuitry 24 or means for processing 24 applying computer-based processing on the image data. In particular, the processor circuitry 24 or means for processing 24 apply the computer-based processing selectively based on the control information. In other words, depending on the one or more modalities specified by the control information, different types of computer-based processing may be applied to the image data. For example, as discussed in connection with FIGS. 1a and 1b, the processor circuitry or means for processing may to execute the machine-readable instructions to apply the computer-based processing by performing at least one storing of the depiction of the user (e.g., for the purpose of training of a machine-learning model, such as a generative machine-learning model), applying person detection on the depiction of the user, applying person identification on the depiction of the user, applying multi-camera tracking on the depiction of the user, and processing the depiction of the user by a machine-learning based system according to the control information. For example, the one or more modalities specified by the control information specify, which of performing at least one storing of the depiction of the user, applying person detection (e.g., using a machine learning-based classifier or person re-identification) on the depiction of the user, applying person identification (e.g., by generating a feature vector that represents the user or a face of the user, and determining the identity of the user by comparing the feature vector with a database of feature vectors) on the depiction of the user, applying multi-camera tracking on the depiction of the user (e.g., using person re-identification), and processing the depiction of the user by a machine-learning based system (e.g., a machine-learning system for performing person re-identification, determination of a feature vector, person classification, anomaly detection etc.) is applied by the processor circuitry or means for processing (e.g., with the help of a dedicated accelerator or graphics processing unit).

To determine, which modality of computer-based processing is (not) to be applied to which portion of the image data, the control information may comprise information on a position of the depiction of the user in the image data. The information on the position of the depiction of the user in the image data (e.g., coordinates of a bounding box) may be used as input parameters to the subsequent computer-based processing of the image data. In effect, the act of applying the computer-based processing on the image data may be based on the position of the depiction of the user in the image data included in the control information. In some cases, e.g., if the user disallows any kind of storing or processing of the depiction of the user, in a pre-processing task, the portion of the image data showing the depiction of the user may be anonymized, e.g., using a blurring filter, or by pixelating the depiction of the user. Alternatively, in some cases, the subsequent computer-based processing tasks may be parametrized to ignore or omit the depiction of the user when processing the image data.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processor circuitry 24 or means for processing 24 may be implemented using one or more processing units, one or more processing devices, any means for processing, such as a processor, a computer or a programmable hardware component being operable with accordingly adapted software. In other words, the described function of the processor circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 26 or means for storing information 26 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the image data processing system 20, computer system 200, system, method and computer program are mentioned in connection with the proposed concept, or one or more examples described above or below (e.g., FIG. 1a to 1b, 3 to 4). The image data processing system 20, computer system 200, system, method and computer program may comprise one or more additional optional features corresponding to one or more aspects of the proposed concept, or one or more examples described above or below.

Various examples of the present disclosure relate to a facial recognition privacy permission system for consent-required use cases.

Various examples of the present disclosure are based on the finding, that video recording systems being used are often not considering the privacy consent and preferences of the population. In a majority of cases, the video recording systems are not requesting person's consent for video recording. In general, privacy preferences may be managed at various levels, e.g., levels of granularity. Some users may reject identification, so their data might be used anonymously (only detected). Other users may agree to be identified by using facial recognition, whereas others may agree to be recognized by advanced algorithms and their data might be stored in AI (Artificial Intelligence)-based databases or other databases or repositories used for training a machine-learning model, e.g., a machine-learning model used for generative AI, such as a transformer-based machine-learning model.

Various examples of the present disclosure may be in line with privacy regulations (e.g., GDPR (General Data Privacy Regulation), CCPA (California Consumer Privacy Act)) and may allow individuals to control their privacy exposure. Examples may provide a set of technological approaches that may allow interactions between individuals and tracking and recording systems, which may be created anew as existing approaches based on user consent may not scale.

By privacy regulations, companies may be required to collect a consent for use of facial recognition technology. Typically, they obtain consent from the user of the device during the enrollment processes. Companies may have internal policies about the use of facial recognition in the workplace. The proposed concept may be used additionally with systems without users onboarding.

In general, privacy facial recognition regulation enforcement may lack two main elements—standardization in privacy preference declaration—(no granularity), and technical approaches to enforce privacy preference regulations in consent required use cases. In the European Union or the People's Republic of China, a data protection impact assessment is mandated, and a privacy policy is applied.

The proposed concept may address both of those issues under the assumption that the law may eventually require such enforcement soon, e.g., and a technical approach to enable it.

Today, the processing of images from surveillance cameras is performed using an all-or-nothing approach, meaning either systems are using facial recognition without all user's consent or not using facial recognition due the inability of applying different privacy policies to different users. There may be no technological approach that supports the needed granularity. In closed systems the users can define their privacy preferences (or at least be aware of system aspects), but in open systems where users do not register upfront, user-based privacy preferences might not be enforceable.

The present disclosure introduces a Personal Privacy Beacon (PPB, e.g., the radio beacon discussed in connection with FIGS. 1a and 1b) that broadcasts a Privacy Memorandum (comprising the user's privacy preferences, e.g., the information on a user selection) to any personal tracking systems in their proximity. A personal tracking system may locate the user in the monitored area, digest the memorandum, and feed it to a Privacy Policy Enforcer. The Privacy Policy Enforcer (PPE) is a module or system that may combine the users' Privacy Memorandum with the system configurations and related regulations and/or policies e.g., security, law-enforcement, to determine the facial recognition restrictions, and select the appropriate privacy anonymization/generalization methods. The PPE may generate the configurations that set/control the authorized advanced computer visions algorithms that operate in a Computer Vision Module. In case the user preference is to keep the user's anonymity, the system might not use facial recognition and instead tag the user and anonymously track the user.

The proposed concept describes a privacy-shield that allows users to control their exposure to facial recognition-based systems while still enabling those systems to generate the desired insights. Those systems enable privacy by design based on user granularity of consent.

In various examples of the present disclosure, users may use a Personal Privacy Beacon—PPB. The PPB may be implemented as a radio beacon, e.g., using Bluetooth Low Energy, WiFi, a fourth generation (4G) cellular network, a fifth generation (5G) cellular network, or may be implemented using manual selection (e.g., at a user terminal) or any other way. The PPB may be used by a user to share the user's personal privacy preferences. Systems may relay and use a Privacy Policy Enforcer (PPE) to track the users. For example, radio signals of the PPB can be detected, or the PPB may be visually inspected. The systems using a PPB/PPE system may publish that they accept user privacy policies.

For example, the proposed concept may be implemented using one or more of the following components: (i) a Personal Privacy Beacon (PPB), a user-owned beacon that broadcasts the user's privacy statement to a receiving unit; (ii) a Privacy Policy Enforcer (PPE) that may combine the users' privacy preferences with its system policy (e.g., security, law-enforcement, public, etc. . . . ), define the facial recognition restrictions, and apply the appropriate privacy anonymization/generalization methods; (iii) a location subsystem—for user location coupling. This subsystem can be deployed using advanced computer vision algorithms or other available algorithms and technologies, its purpose is to identify the location of the user in the photograph/video stream.

Below is a detailed explanation of an example of the proposed concept of facial recognition privacy permission system for consent-required use cases.

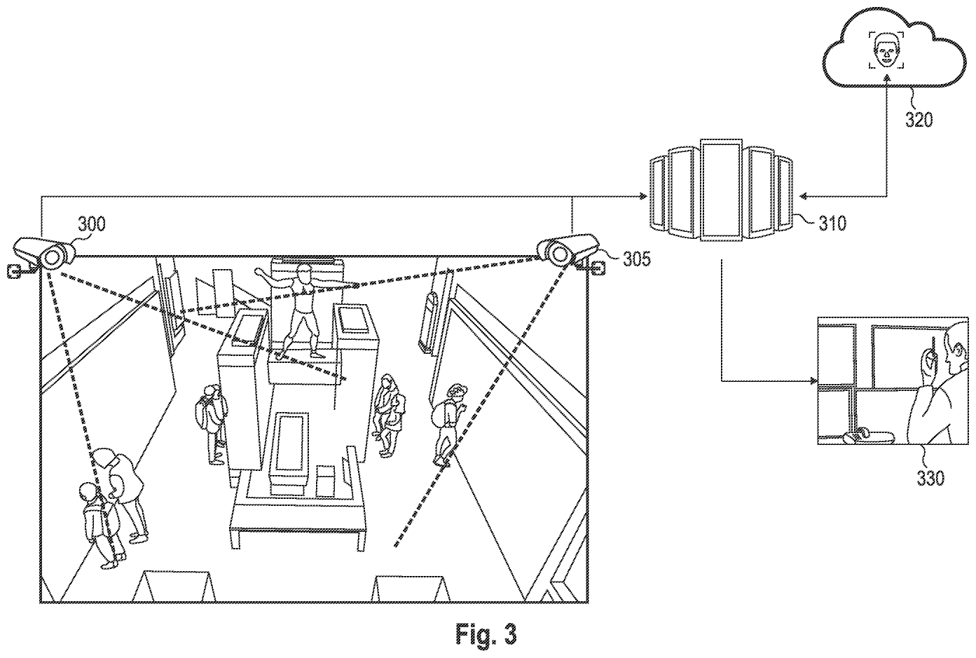

In general, there are monitoring systems that can detect, identify, and recognize individuals. Those system are ranging from single cameras CCTV to multi-object multi-camera tracking (MOMCT) based on deep learning for intelligent systems. FIG. 3 shows a schematic diagram of a video surveillance system, e.g., a video surveillance system that may be designed without concerns to user privacy. In FIG. 3, a simple multi-camera tracking system is shown, where two cameras 300; 305 are tracking individuals in a museum, the video stream is processed in a centralized server 310, the facial recognition process is being done in a cloud environment 320 and the identified users are being monitored in real-time by the museum security team 330.

FIG. 4 shows a schematic diagram of an example of the proposed concept. FIG. 4 shows a user carrying a Personal Privacy Beacon 400 that broadcasts the user privacy preference. FIG. 4 further shows a first camera 410 providing video stream input (for the purpose of user privacy tagging, e.g., without sophisticated algorithms for face recognition). FIG. 4 further shows a user tagging manager 420, which tags the user when first observed, integrates the privacy beacon and the user tag (which is coupled to its location) into one entity, creating Temp (e.g., temporary) Tags that contain the initial tagging of the users, integrating the users' privacy preference with its' unique indicators that do not require facial recognition. The aforementioned components are part of a first phase, which is used for user privacy tagging. FIG. 4 further shows a Local Privacy Policy 440 (e.g., the information on legally allowed modalities)—The privacy policy of the venue/enforced by the local authority, for example, in different privacy terms applied to public areas (library, hospitals, airports, etc.) vs. private domains (shopping centers, office buildings, etc.). In some cases of authorized required monitoring, the personal privacy preferences may be overruled. In cases the privacy consent applies, the privacy preferences are taken. FIG. 4 further show the Privacy Policy Enforcer 430 that processes the user privacy preferences with the local privacy policy to an integrated privacy policy (e.g., the one or more modalities of computer-based processing to be applied to the depiction of the user in the image data) and passes the output to the user tagging manager. FIG. 4 further shows a User Tracking System Camera/Multi-Cameras 450—this complex may capture the user after the initial tagging and continuously update its tagging according to the needs. FIG. 4 further shows a Computer Vision Module 460 (several models exist), which is used for image processing. The Computer Vision Module 460 (e.g., the image data processing system) may analyze the user according to the PPE (including advanced facial recognition algorithms).

More details and aspects of the facial recognition privacy permission system for consent-required use cases are mentioned in connection with the proposed concept or one or more examples described above or below (e.g., FIG. 1a to 2b). The facial recognition privacy permission system for consent-required use cases may comprise one or more additional optional features corresponding to one or more aspects of the proposed concept, or one or more examples described above or below.

In the following, some examples of the proposed concept are presented:

An example (e.g., example 1) relates to an apparatus (10) for providing control information for an image data processing system (20), the apparatus comprising interface circuitry (12), machine-readable instructions, and processor circuitry (14) to execute the machine-readable instructions to obtain information on a user selection from a user, the user selection relating to at least one modality of computer-based processing of a depiction of the user the user is comfortable or uncomfortable with, determine a presence of a depiction of the user in image data of a camera (101), and determine one or more modalities of computer-based processing to be applied to the depiction of the user in the image data based on the user selection, provide control information regarding the one or more modalities of computer-based processing to be applied to the depiction of the user in the image data for the image data processing system (20).

Another example (e.g., example 2) relates to a previous example (e.g., example 1) or to any other example, further comprising that the processor circuitry is to execute the machine-readable instructions to obtain information on legally allowed modalities of computer-based processing, and to determine the one or more modalities of computer-based processing to be applied to the depiction of the user in the image data further based on the information on the legally allowed modalities of computer-based processing.

Another example (e.g., example 3) relates to a previous example (e.g., example 2) or to any other example, further comprising that the legally allowed modalities of computer-based processing are based on a legal framework under which the image data processing system is used.

Another example (e.g., example 4) relates to a previous example (e.g., one of the examples 2 or 3) or to any other example, further comprising that the processor circuitry is to execute the machine-readable instructions to determine an environment the image data is recorded in, and to determine the one or more modalities of computer-based processing to be applied to the depiction of the user in the image data based on the legally allowed modality of computer-based processing of the environment.

Another example (e.g., example 5) relates to a previous example (e.g., example 4) or to any other example, further comprising that the environment is one of a public environment, a public transportation environment, an airport environment, a corporate environment, and a private environment.

Another example (e.g., example 6) relates to a previous example (e.g., one of the examples 1 to 5) or to any other example, further comprising that the processor circuitry is to execute the machine-readable instructions to obtain the information on the user selection from a signal emitted by a radio beacon (5a) carried by the user.

Another example (e.g., example 7) relates to a previous example (e.g., example 6) or to any other example, further comprising that the processor circuitry is to execute the machine-readable instructions to process at least a content of the signal emitted by the radio beacon carried by the user to determine the information on the user selection.

Another example (e.g., example 8) relates to a previous example (e.g., example 7) or to any other example, further comprising that the signal is one of a Bluetooth signal, a WiFi signal, a Near-Field Communication signal and a cellular communication signal.

Another example (e.g., example 9) relates to a previous example (e.g., one of the examples 1 to 8) or to any other example, further comprising that the processor circuitry is to execute the machine-readable instructions to obtain the information on the user selection from a visual tag worn by the user and included in the image data.

Another example (e.g., example 10) relates to a previous example (e.g., one of the examples 1 to 9) or to any other example, further comprising that the processor circuitry is to execute the machine-readable instructions to obtain the information on the user selection from a manual input provided by the user at an input terminal (103).

Another example (e.g., example 11) relates to a previous example (e.g., one of the examples 1 to 10) or to any other example, further comprising that a modality of computer-based processing is one of storing of the depiction of the user, person detection being applied on the depiction of the user, person identification being applied on the depiction of the user, multi-camera tracking being applied on the depiction of the user, and processing of the depiction of the user by a machine-learning based system.

Another example (e.g., example 12) relates to a previous example (e.g., one of the examples 1 to 11) or to any other example, further comprising that the processor circuitry is to execute the machine-readable instructions to determine a position of the depiction of the user in the image data, and to provide the control information with information on the position of the depiction of the user in the image data.

An example (e.g., example 13) relates to an apparatus (10) for providing control information for an image data processing system (20), the apparatus comprising processor circuitry (14) configured to obtain information on a user selection from a user, the user selection relating to at least one modality of computer-based processing of a depiction of the user the user is comfortable or uncomfortable with, determine a presence of a depiction of the user in image data of a camera (101), and determine one or more modalities of computer-based processing to be applied to the depiction of the user in the image data based on the user selection, provide control information regarding the one or more modalities of computer-based processing to be applied to the depiction of the user in the image data for the image data processing system (20).

An example (e.g., example 14) relates to a device (10) for providing control information for an image data processing system (20), the apparatus comprising means for processing for obtaining information on a user selection from a user, the user selection relating to at least one modality of computer-based processing of a depiction of the user the user is comfortable or uncomfortable with, determining a presence of a depiction of the user in image data of a camera (101), and determining one or more modalities of computer-based processing to be applied to the depiction of the user in the image data based on the user selection, providing control information regarding the one or more modalities of computer-based processing to be applied to the depiction of the user in the image data for the image data processing system (20).

Another example (e.g., example 15) relates to a computer system (100) comprising the apparatus (10) or device (10) according to one of the examples 1 to 14.

An example (e.g., example 16) relates to an image data processing system (20) comprising interface circuitry (22), machine-readable instructions, and processor circuitry (24) to execute the machine-readable instructions to obtain image data from at least one camera (101), obtain control information regarding one or more modalities of computer-based processing to be applied to a depiction of a user in the image data, and apply computer-based processing on the image data according to the control information.

Another example (e.g., example 17) relates to a previous example (e.g., example 16) or to any other example, further comprising that the processor circuitry is to execute the machine-readable instructions to apply the computer-based processing by performing at least one storing of the depiction of the user, applying person detection on the depiction of the user, applying person identification on the depiction of the user, applying multi-camera tracking on the depiction of the user, and processing the depiction of the user by a machine-learning based system according to the control information.

Another example (e.g., example 18) relates to a previous example (e.g., one of the examples 16 or 17) or to any other example, further comprising that the control information comprises information on a position of the depiction of the user in the image data, wherein the act of applying the computer-based processing on the image data is based on the position of the depiction of the user in the image data included in the control information.

An example (e.g., example 19) relates to an image data processing system (20) comprising processor circuitry (24) configured to obtain image data from at least one camera (101), obtain control information regarding one or more modalities of computer-based processing to be applied to a depiction of a user in the image data, and apply computer-based processing on the image data according to the control information.

An example (e.g., example 20) relates to an image data processing system (20) comprising means for processing (24) for obtaining image data from at least one camera (101), obtaining control information regarding one or more modalities of computer-based processing to be applied to a depiction of a user in the image data, and applying computer-based processing on the image data according to the control information.

Another example (e.g., example 21) relates to the image data processing system according to one of the examples 16 to 20, further comprising the apparatus (10) or device (10) according to one of the examples 1 to 14.

Another example (e.g., example 22) relates to a computer system comprising the image data processing system (20) according to one of the examples 16 to 21.

An example (e.g., example 23) relates to a method for providing control information for an image data processing system, the method comprising obtaining (110) information on a user selection from a user, the user selection relating to at least one modality of computer-based processing of a depiction of the user the user is comfortable or uncomfortable with, determining (120) a presence of a depiction of the user in image data of a camera (101), and determining (140) one or more modalities of computer-based processing to be applied to the depiction of the user in the image data based on the user selection, providing (150) control information regarding the one or more modalities of computer-based processing to be applied to the depiction of the user in the image data for the image data processing system (20).

Another example (e.g., example 24) relates to a previous example (e.g., example 23) or to any other example, further comprising that the method comprises obtaining (130) information on legally allowed modalities of computer-based processing and determining (140) the one or more modalities of computer-based processing to be applied to the depiction of the user in the image data further based on the information on the legally allowed modalities of computer-based processing.

Another example (e.g., example 25) relates to a previous example (e.g., example 24) or to any other example, further comprising that the legally allowed modalities of computer-based processing are based on a legal framework under which the image data processing system is used.

Another example (e.g., example 26) relates to a previous example (e.g., one of the examples 24 or 25) or to any other example, further comprising that the method comprises determining (135) an environment the image data is recorded in and determining (140) the one or more modalities of computer-based processing to be applied to the depiction of the user in the image data based on the legally allowed modality of computer-based processing of the environment.

Another example (e.g., example 27) relates to a previous example (e.g., example 26) or to any other example, further comprising that the environment is one of a public environment, a public transportation environment, an airport environment, a corporate environment, and a private environment.

Another example (e.g., example 28) relates to a previous example (e.g., one of the examples 23 to 27) or to any other example, further comprising that the method comprises obtaining (110) the information on the user selection from a signal emitted by a radio beacon (5a) carried by the user.

Another example (e.g., example 29) relates to a previous example (e.g., example 28) or to any other example, further comprising that the method comprises processing (115) at least a content of the signal emitted by the radio beacon carried by the user to determine the information on the user selection.

Another example (e.g., example 30) relates to a previous example (e.g., example 29) or to any other example, further comprising that the signal is one of a Bluetooth signal, a WiFi signal, a Near-Field Communication signal and a cellular communication signal.

Another example (e.g., example 31) relates to a previous example (e.g., one of the examples 23 to 27) or to any other example, further comprising that the method comprises obtaining (110) the information on the user selection from a visual tag worn by the user and included in the image data.

Another example (e.g., example 32) relates to a previous example (e.g., one of the examples 23 to 27) or to any other example, further comprising that the method comprises obtaining (110) the information on the user selection from a manual input provided by the user at an input terminal (103).

Another example (e.g., example 33) relates to a previous example (e.g., one of the examples 23 to 32) or to any other example, further comprising that a modality of computer-based processing is one of storing of the depiction of the user, person detection being applied on the depiction of the user, person identification being applied on the depiction of the user, multi-camera tracking being applied on the depiction of the user, and processing of the depiction of the user by a machine-learning based system.

Another example (e.g., example 34) relates to a previous example (e.g., one of the examples 23 to 33) or to any other example, further comprising that the method comprises determining (125) a position of the depiction of the user in the image data and providing (150) the control information with information on the position of the depiction of the user in the image data.

Another example (e.g., example 35) relates to a computer system (100) configured to perform the method of one of the examples 23 to 34.

An example (e.g., example 36) relates to an image data processing method comprising obtaining (210) image data from at least one camera (101), obtaining (220) control information regarding one or more modalities of computer-based processing to be applied to a depiction of a user in the image data, and applying (230) computer-based processing on the image data according to the control information.

Another example (e.g., example 37) relates to a previous example (e.g., example 36) or to any other example, further comprising that the method comprises applying the computer-based processing by performing at least one storing of the depiction of the user, applying person detection on the depiction of the user, applying person identification on the depiction of the user, applying multi-camera tracking on the depiction of the user, and processing the depiction of the user by a machine-learning based system according to the control information.

Another example (e.g., example 38) relates to a previous example (e.g., one of the examples 36 or 37) or to any other example, further comprising that the control information comprises information on a position of the depiction of the user in the image data, the method comprising applying (230) the computer-based processing on the image data based on the position of the depiction of the user in the image data included in the control information.

Another example (e.g., example 39) relates to a computer system (200) configured to perform the method of one of the examples 36 to 38.

Another example (e.g., example 40) relates to the computer system (200) according to example 39, wherein the computer system is further configured to perform the method of one of the examples 23 to 34.

Another example (e.g., example 41) relates to a non-transitory, computer-readable medium comprising a program code that, when the program code is executed on a processor, a computer, or a programmable hardware component, causes the processor, computer, or programmable hardware component to perform at least one of the method of one of the examples 23 to 34 and the method of one of the examples 36 to 38.

Another example (e.g., example 42) relates to a non-transitory machine-readable storage medium including program code, when executed, to cause a machine to perform at least one of the method of one of the examples 23 to 34 and the method of one of the examples 36 to 38.

Another example (e.g., example 43) relates to a computer program having a program code for performing at least one of the method of one of the examples 23 to 34 and the method of one of the examples 36 to 38 when the computer program is executed on a computer, a processor, or a programmable hardware component.

Another example (e.g., example 44) relates machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for providing control information for an image data processing system, the apparatus comprising interface circuitry, machine-readable instructions, and processor circuitry to execute the machine-readable instructions to:
obtain information on a user selection from a user, the user selection relating to at least one modality of computer-based processing of a depiction of the user the user is comfortable or uncomfortable with;
determine a presence of a depiction of the user in image data of a camera; and
determine one or more modalities of computer-based processing to be applied to the depiction of the user in the image data based on the user selection;
provide control information regarding the one or more modalities of computer-based processing to be applied to the depiction of the user in the image data for the image data processing system.

2. The apparatus according to claim 1, wherein the processor circuitry is to execute the machine-readable instructions to obtain information on legally allowed modalities of computer-based processing, and to determine the one or more modalities of computer-based processing to be applied to the depiction of the user in the image data further based on the information on the legally allowed modalities of computer-based processing.

3. The apparatus according to claim 2, wherein the legally allowed modalities of computer-based processing are based on a legal framework under which the image data processing system is used.

4. The apparatus according to claim 2, wherein the processor circuitry is to execute the machine-readable instructions to determine an environment the image data is recorded in, and to determine the one or more modalities of computer-based processing to be applied to the depiction of the user in the image data based on the legally allowed modality of computer-based processing of the environment.

5. The apparatus according to claim 4, wherein the environment is one of a public environment, a public transportation environment, an airport environment, a corporate environment, and a private environment.

6. The apparatus according to claim 1, wherein the processor circuitry is to execute the machine-readable instructions to obtain the information on the user selection from a signal emitted by a radio beacon carried by the user.

7. The apparatus according to claim 6, wherein the processor circuitry is to execute the machine-readable instructions to process at least a content of the signal emitted by the radio beacon carried by the user to determine the information on the user selection.

8. The apparatus according to claim 7, wherein the signal is one of a Bluetooth signal, a WiFi signal, a Near-Field Communication signal and a cellular communication signal.

9. The apparatus according to claim 1, wherein the processor circuitry is to execute the machine-readable instructions to obtain the information on the user selection from a visual tag worn by the user and included in the image data.

10. The apparatus according to claim 1, wherein the processor circuitry is to execute the machine-readable instructions to obtain the information on the user selection from a manual input provided by the user at an input terminal.

11. The apparatus according to claim 1, wherein a modality of computer-based processing is one of storing of the depiction of the user, person detection being applied on the depiction of the user, person identification being applied on the depiction of the user, multi-camera tracking being applied on the depiction of the user, and processing of the depiction of the user by a machine-learning based system.

12. The apparatus according to claim 1, wherein the processor circuitry is to execute the machine-readable instructions to determine a position of the depiction of the user in the image data, and to provide the control information with information on the position of the depiction of the user in the image data.

13. An image data processing system comprising interface circuitry, machine-readable instructions, and processor circuitry to execute the machine-readable instructions to:
obtain image data from at least one camera;
obtain control information regarding one or more modalities of computer-based processing to be applied to a depiction of a user in the image data; and
apply computer-based processing on the image data according to the control information.

14. The image data processing system according to claim 13, wherein the processor circuitry is to execute the machine-readable instructions to apply the computer-based processing by performing at least one storing of the depiction of the user, applying person detection on the depiction of the user, applying person identification on the depiction of the user, applying multi-camera tracking on the depiction of the user, and processing the depiction of the user by a machine-learning based system according to the control information.

15. The image data processing system according to claim 13, wherein the control information comprises information on a position of the depiction of the user in the image data, wherein the act of applying the computer-based processing on the image data is based on the position of the depiction of the user in the image data included in the control information.

16. A method for providing control information for an image data processing system, the method comprising:
obtaining information on a user selection from a user, the user selection relating to at least one modality of computer-based processing of a depiction of the user the user is comfortable or uncomfortable with;
determining a presence of a depiction of the user in image data of a camera; and
determining one or more modalities of computer-based processing to be applied to the depiction of the user in the image data based on the user selection;
providing control information regarding the one or more modalities of computer-based processing to be applied to the depiction of the user in the image data for the image data processing system.

17. A non-transitory, computer-readable medium comprising a program code that, when the program code is executed on a processor, a computer, or a programmable hardware component, causes the processor, computer, or programmable hardware component to perform the method of claim 16.
